(19) United States
(12) Patent Application Publication
(10) Pub. No.: US 2012/0164953 A1
(43) Pub. Date: Jun. 28, 2012

(54) Method And Apparatus For Sensing Movement

(75) Inventor: Ja Beom GU, Daejeon-si (KR)

(73) Assignee: Electronics and Telecommunications Research Institute, Daejeon (KR)

(21) Appl. No.: 13/335,837

(22) Filed: Dec. 22, 2011

(30) Foreign Application Priority Data
Dec. 23, 2010 (KR) 10-2010-0133707

(51) Int. Cl. H04B 17/00

(52) U.S. Cl. 455/67.11

(57) ABSTRACT

A method and an apparatus for sensing movement using wireless communication are provided. The method includes: receiving radio waves transmitted from a movement sensed target and collecting information on predetermined characteristics of the radio waves; calculating a change amount in characteristics of the radio waves based on the information on characteristics of the radio waves; determining whether the change amount in characteristics of the radio waves is a predetermined threshold or more; and determining that movement has been made between an apparatus for sensing movement and the movement sensed target when the change amount in characteristics of the radio waves is the predetermined threshold or more as a result of the judgment.

### CROSS-REFERENCE TO RELATED APPLICATIONS

This application claims the benefit of priority of Korean Patent Application No. 10-2010-0133707 filed on Dec. 23, 2010, all of which are incorporated by reference in their entirety herein.

### BACKGROUND OF THE INVENTION

1. Field of the Invention

The present invention relates to a wireless communication technology, and more particularly, to a method for sensing movement using a change in characteristics of radio waves generated in radio wave channels between wireless apparatuses.

2. Related Art

Technologies of sensing movement of a target of interest using a wireless communication technology have been used.

Up to now, a method for sensing movement has been realized in various schemes such as a scheme measuring a distance using an ultrasonic sensor, a laser sensor, an infrared sensor, or the like, a scheme using a computer vision, or the like, a contact scheme using a magnetic property, a contactless proximity scheme using a radio frequency identity (RFID) technology, or the like.

In these scheme, when a movement sensed target object which means a target object of which movement is to be sensed and a sensor are disposed at a distance close to each other such as a visibility range, a line of sight is secured, or the target object and the sensor may be in direct contact with each other, an effect may be accomplished. Therefore, an operation radius of the sensor is narrow.

Further, in the case of the laser sensor or the infrared sensor, it is difficult to realize omnidirectional sensing. In addition, the line of sight should be secured by allowing sensing directions of the sensor and the sensed target which means the target to be sensed (detected) to coincide with each other in order to use the laser sensor or the infrared sensor.

In accordance with the recent development of the wireless communication technology, a method of finding a relative position of a wireless communication terminal based on physical registration position information of a wireless access point (AP) has been used. However, this method has a large error in sensing movement of the sensed target in real time.

### SUMMARY OF THE INVENTION

The present invention provides a method and an apparatus for sensing movement of a sensed target in real time.

The present invention also provides a method capable of sensing movement of a sensed target even in the case in which an obstacle is present between the sensed target and a sensor or a line of sight is not secured.

The present invention also provides a method for sensing omnidirectional movement of a sensed target.

The present invention also provides a method capable of sensing movement of a sensed target without directly contacting the sensed target or being positioned at a distance close to the sensed target.

In an aspect, a method for sensing movement is provided. The method includes: receiving radio waves transmitted from a movement sensed target and collecting information on predetermined characteristics of the radio waves; calculating a change amount in characteristics of the radio waves based on the information on characteristics of the radio waves; determining whether the change amount in characteristics of the radio waves is a predetermined threshold or more; and determining that movement has been made between an apparatus for sensing movement and the movement sensed target when the change amount in characteristics of the radio waves is the predetermined threshold or more as a result of the judgment.

The information on characteristics of the radio waves may be at least one of information on channel impulse response and information on received signal strength.

The method may further include setting a parameter corresponding to a reference position of the movement sensed target and a parameter corresponding to movement with respect to the reference position, wherein when it is judged that the movement has been made between the apparatus for sensing movement and the movement sensed target, an operation indicated by the parameter corresponding to the movement is performed.

In the setting of the parameter corresponding to the movement, a parameter corresponding to a movement direction of the movement may be set, and when it is judged that the movement has been made, a command indicated by the parameter corresponding to the movement direction of the movement may be performed by sensing the movement direction of the movement.

The method may further include outputting a message informing the movement when it is judged that the movement has been made between the apparatus for sensing movement and the movement sensed target.

The message may be alert output as a sound.

The method may further include initializing a position of the movement sensed target after it is judged that the movement has been made, wherein the collecting of the information on characteristics of the radio waves, the calculating of the change amount in characteristics of the radio waves, the determining whether the change amount in characteristics of the radio waves is a predetermined threshold or more, and the determining that movement has been made between an apparatus for sensing movement and the movement sensed target are again performed with respect to the movement sensed target.

In another aspect, an apparatus for sensing movement is provided. The apparatus includes: a transceiving unit receiving signals from a movement sensed target; a characteristic collecting unit collecting information on characteristics of radio waves of the signals received by the transceiving unit; and a movement detecting unit determining whether movement has been made between an apparatus for sensing movement and the movement sensed target based on the information on characteristics of radio waves collected by the characteristic collecting unit, wherein the movement detecting unit judges that the movement has been made between the apparatus for sensing movement and the movement sensed target when a change amount in the information on characteristics of the radio waves is a predetermined threshold or more.

The apparatus may further include a controlling unit taking corresponding action when the movement detecting unit judges that the movement has been made.

The characteristics collecting unit may have an indication parameter set to take predetermined action corresponding to each movement direction based on an initial position with respect to the movement sensed target, the movement detecting unit may detect the movement direction together with whether or not the movement of the movement sensed target has been made, and the controlling unit may take action indicated by an indication parameter corresponding to the movement direction of the movement sensed target detected by the movement detecting unit.

The transceiving unit may transmit information on the movement judged by the movement detecting unit to a control center managing the movement sensed target, and the transmission of the information on the movement may be performed by request of the control center and/or periodically.

The apparatus may further include a displaying unit outputting information on the movement judged by the movement detecting unit.

The displaying unit may include a sound outputting unit outputting a sound, wherein the sound outputting unit outputs a predetermined sound when the movement detecting unit judges that the movement has been made between the apparatus for sensing movement and the movement sensed target.

### BRIEF DESCRIPTION OF THE DRAWINGS

FIG. 1 is a diagram schematically showing an exemplary embodiment of the present invention.

FIG. 2 is a block diagram schematically describing a configuration of a wireless communication apparatus according to the exemplary embodiment of the present invention.

FIG. 3 is a flow chart schematically describing a method for determining whether or not movement has been made in a system according to the exemplary embodiment of the present invention.

FIG. 4 is a diagram schematically describing an example of preventing theft of an article using the system according to the exemplary embodiment of the present invention.

FIG. 5 is a view schematically showing a method for recognizing and using a movement direction of a remote controller according to the exemplary embodiment of the present invention.

FIG. 6 is a diagram schematically describing a method for coping with a disaster according to the exemplary embodiment of the present invention.

### DESCRIPTION OF EXEMPLARY EMBODIMENTS

Characteristics of radio wave channels and radio waves are temporally and spatially changed due to interference generated in the radio wave channels between two wireless apparatuses using a single frequency band.

A phenomenon that characteristics of the radio waves are changed according to a time is called fading. Even though the characteristics of the radio waves are changed with the passage of time, they are not significantly changed in a short time.

Unlike a temporal change, in the case of a spatial change, even though a target transmitting the radio waves moves only several centimeters, the characteristics of the radio waves are rapidly changed. For example, in the case of Wi-Fi using a 2.4 GHz band, even though the target transmitting the radio waves moves only 6 cm, the characteristics of the radio waves are significantly different from those of the radio waves transmitted at a position of the target before being moved.

Since the characteristics of the radio waves are uniquely observed between two wireless communication apparatuses transceiving the radio waves, a first wireless communication apparatus may judge whether or not a second wireless communication apparatus has spatially moved by sensing a change in the characteristics of the radio waves. Here, since the movement changing the characteristics of the radio waves is relative movement between the first and second wireless communication apparatuses, in the case in which the first wireless communication apparatus moves as well as in the case in which the second wireless communication apparatus moves, the movement may be sensed.

According to the present invention, a method and an apparatus for sensing movement of any one of two wireless communication apparatuses by sensing a change due to interference of radio wave channels used between the two wireless communication apparatuses are provided.

Hereinafter, exemplary embodiments of the present invention will be described in detail with reference to the accompanying drawings. It is to be noted that in giving reference numerals to components of each of the accompanying drawing, like reference numerals refer to like elements even though the like components are shown in different drawings. Further, in describing exemplary embodiments of the present invention, well-known functions or constructions will not be described in detail since they may unnecessarily obscure the understanding of the present invention.

In addition, in describing components of the present specification, terms such as first, second, A, B, (a), (b), etc. may be used. These terms are used only to differentiate the components from other components. Therefore, the nature, times, sequence, etc. of the corresponding components are not limited by these terms. When any components are “connected”, “coupled”, or “linked” to other components, it is to be noted that the components may be directly connected or linked to other components, but the components may be “connected”, “coupled”, or “linked” to other components via another component therebetween.

Further, in the present invention, “including” a specific configuration will be understood that additional configuration may also be included in the embodiments or the scope of the technical idea of the present invention.

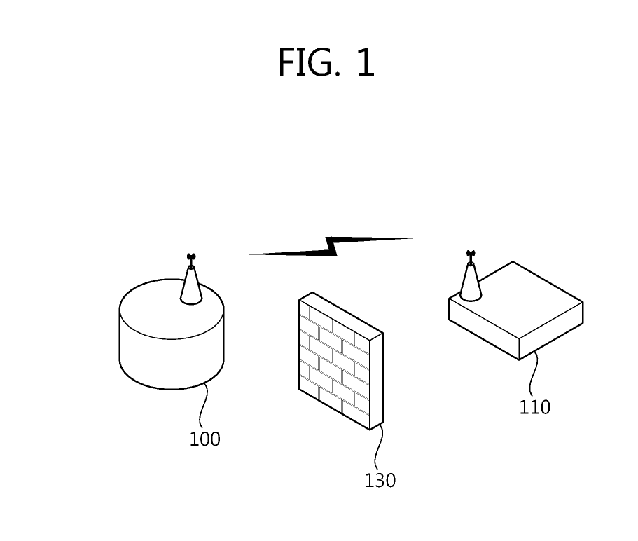

FIG. 1 is a diagram schematically showing an exemplary embodiment of the present invention.

First and second wireless communication apparatuses 100 and 110 support the same wireless communication scheme. The first and second wireless communication apparatuses 100 and 110 transceive signals using the same wireless communication scheme, for example, Wi-Fi.

Here, it is assumed that the second wireless communication apparatus 110 is a movement sensed target and the first wireless communication apparatus 100 is a sensing apparatus for sensing movement of the second wireless communication apparatus 110. The first wireless communication apparatus 100 may judge whether the second wireless communication apparatus 110 has relatively moved with respect to the first wireless communication apparatus 100 by sensing a change in characteristics of radio waves transmitted by the second wireless communication apparatus 110.

As shown, an obstacle 120 obstructing communication, such as a building, a wall, a person, an automobile, or the like, may be present between the first and second wireless communication apparatuses 100 and 110. In this case, even though the radio waves may be attenuated by the obstacle 120, the first wireless communication apparatus 100 may communicate with the second wireless communication apparatus 110. Therefore, the first wireless communication apparatus 100 may judge whether or not the second wireless communication apparatus 110 has moved by sensing the change in characteristics of the radio waves.

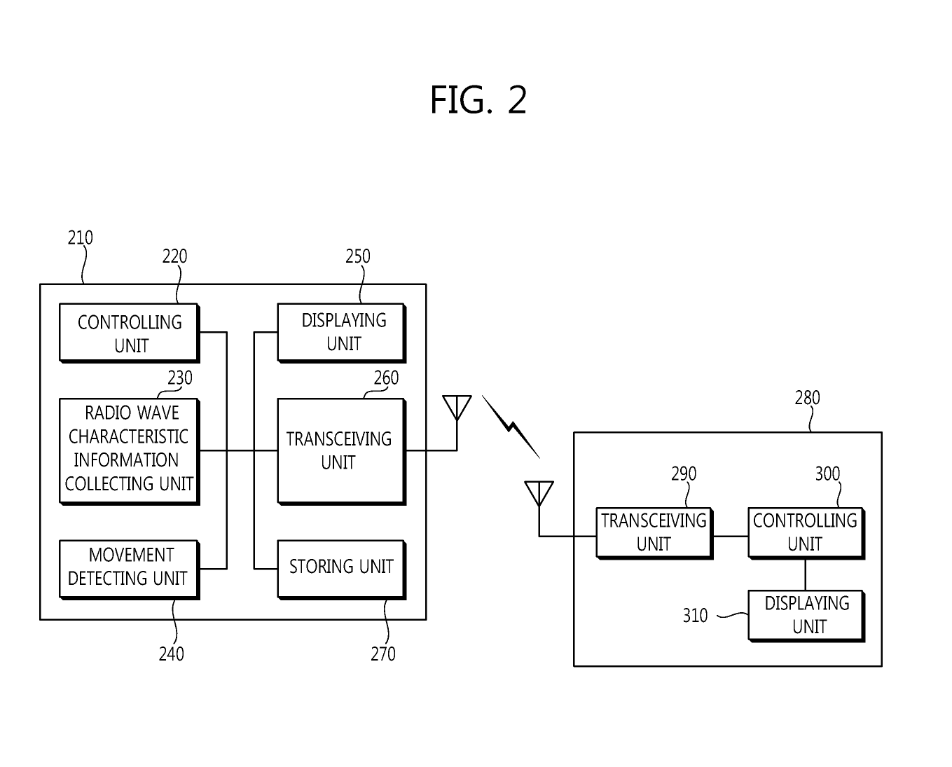

FIG. 2 is a block diagram schematically describing a configuration of a wireless communication apparatus according to the exemplary embodiment of the present invention.

First and second wireless communication apparatuses 210 and 280 transceive wireless signals using the same communication scheme, for example, Wi-Fi.

Here, it is assumed that the first wireless communication apparatus 210 is an apparatus for sensing movement and the second wireless communication apparatus 280 is a movement sensed target.

In the present invention, the movement is relative movement between the first and second wireless communication apparatuses 210 and 280. However, for convenience of explanation, a case in which the first wireless communication apparatus 210 is fixed will be described with reference to FIG. 2.

The first wireless communication apparatus 210 may judge whether the second wireless communication apparatus 280 has moved by sensing a change in characteristics of radio waves transmitted by the second wireless communication apparatus 280.

The first wireless communication apparatus 210 includes a radio wave characteristic information collecting unit 230, a movement detecting unit 240, and a transceiving unit 260. In addition, the first wireless communication apparatus 210 may include a controlling unit 220, a displaying unit 250, and/or a storing unit 270.

The transceiving unit 260 may receive radio waves transmitted from the second wireless communication apparatus 280 and transmit signals to the second wireless communication apparatus 280 if needed. In addition, the transceiving unit 260 may transmit information on movement of the second wireless communication apparatus 280 to a system management center, or the like, managing a system, and receive required instructions from the system management center, or the like.

The radio wave characteristic information collecting unit 230 collects information on predetermined radio wave characteristics with respect to the radio waves transmitted by the second wireless communication apparatus 280, through the transceiving unit 260.

Information that may be utilized as the information on radio wave characteristics is various. For example, whether the second wireless communication apparatus 280 moves may be judged based on various information on radio wave characteristics, such as information on channel impulse response, a received signal strength indicator (RSSI), or the like, that may be extracted from data signals transceived through wireless communication apparatuses. Here, available information on radio wave characteristics may be changed according to characteristics, schemes, designs, or the like, of the wireless communication apparatuses.

The movement detecting unit 240 detects a change in the predetermined radio wave characteristics collected by the radio wave characteristic information collecting unit 230. The change in the radio wave characteristics may be a change according to a time or a change according to spatial movement of a subject transmitting the radio waves. As described above, the radio wave characteristics according to the time are not rapidly changed in a short time. Therefore, when the radio wave characteristics are rapidly changed in a short time, this change may be judged to be a change due to movement of the subject transmitting the radio waves.

The movement detecting unit 240 may also periodically detect a change in radio wave characteristics from a point of time at which movement starts to be sensed with respect to a temporal change in radio wave characteristics generated due to the fading. Therefore, it is possible to sense a rapid change in the radio wave characteristics due to the movement as well as a change in the radio wave characteristics due to the passage of time.

When a change amount in the information on the predetermined radio wave characteristics is equal to or exceeds a predetermined threshold, the movement detecting unit 240 may judge that the second wireless communication apparatus 280 transmitting the radio waves has moved. The threshold may be set before the wireless communication apparatus 210 is used, be received from the system management center managing the network system in wireless, or be set by a user through a user interface that may be provided in the displaying unit 250, or the like.

The controlling unit 220 may perform the initiation of the movement detection and/or the selection of the detection sensor. In addition, the controlling unit 220 may also control a setting procedure of selecting and recognizing a detected target wireless communication apparatus.

Each of the operation units 230 to 270 may also be controlled through the controlling unit 220 as needed. In addition, each of the operation units 230 to 270 may be automatically operated according to a predetermined setting of the system rather than being controlled by the controlling unit 220. In this case, the first wireless communication apparatus 210 may also not include the controlling unit 220.

In this connection, the first wireless communication apparatus 210 operating as a movement detecting apparatus may also automatically or manually set the initiation of the movement detection and/or the setting of the detection sensor, corresponding to an operating scheme of the second wireless communication apparatus 280, which is the movement detected target. In addition, the first wireless communication apparatus 210 may include a user interface through the displaying unit 250, or the like, if needed. Information required by the user may be input or parameters required for performing the movement detection may be set, through the user interface.

When it is judged by the movement detecting unit 240 that the second wireless communication apparatus 280 has moved, the controlling unit 220 may take required action. For example, the controlling unit 220 may transmit the fact that the second wireless communication apparatus 280 moves and information on the movement of the second wireless communication apparatus 280 to the system management center or the system user through the transceiving unit 260.

The controlling unit 220 may also display the information on the movement of the second wireless communication apparatus 280 through the displaying unit 250. In addition, the controlling unit 220 may generate the information on the movement of the second wireless communication apparatus 280 and store the information in the storing unit 270.

The displaying unit 250 may display information required for sensing the movement or information on results of performing the movement sensing. For example, the displaying unit 250 may display the information on the movement sensed target, that is, the second wireless communication apparatus 280, such as identification (ID), an original position, or the like, of the movement sensed target, and display the information on results of performing the movement sensing, such as whether or not the movement sensed target moves, a movement distance, a movement speed, or the like, of the movement sensed target.

In addition, the displaying unit 250 may also include a sound outputting device such as speaker, or the like. In this case, the displaying unit 250 may provide voice guide on the movement of the second wireless communication apparatus 280 and generate an alarm sound according to the setting.

The storing unit 270 may store the information required for sensing the movement or the information on the result of sensing the movement. For example, the storing unit 270 may store the information on the second wireless communication apparatus 280, the threshold of radio wave characteristics set in order to judge whether or not the second wireless communication apparatus 280 has moved, or the like. In addition, the storing unit 270 may store the information on the radio wave characteristics collected by the radio wave characteristic collecting unit 230, or the like, and may also store the information on the movement of the second wireless communication apparatus 280 generated by the controlling unit 220.

The second wireless communication apparatus 280, which is the movement sensed target, may include a transceiving unit 290, a controlling unit 300, and a displaying unit 310.

The transceiving unit 290 may transmit the radio waves to the first wireless communication apparatus 210 and receive required information. The transceiving unit 290 may transmit the radio waves at a predetermined period by the setting of the first wireless communication apparatus 210 and transmit the radio waves by the control of the controlling unit 300. In addition, the transmitting unit 290 may also transmit the radio waves according to the setting input by the user through the user interface that may be provided in the displaying unit 310, or the like.

The controlling unit 300 may perform the initiation of the movement detection and/or the selection of the detection sensor. In addition, the controlling unit 300 may also control a setting procedure of selecting and recognizing the first wireless communication apparatus 210 detecting the movement.

Each of operation units 290 and 310 may also be controlled through the controlling unit 220 as needed. In addition, each of the operation units 290 and 310 may be automatically operated according to a predetermined setting of the system rather than being controlled by the controlling unit 300. In this case, the second wireless communication apparatus 280 may also not include the controlling unit 300.

In this connection, the second wireless communication apparatus 280, which is the movement sensed target, may also automatically or manually set the initiation of the movement detection and/or the setting of the detection sensor, corresponding to an operating scheme of the first wireless communication apparatus 210, which is the movement detecting apparatus. In addition, the second wireless communication apparatus 280 may include a user interface through the displaying unit 310, or the like, if needed. Information required by the user may be input or parameters required for performing movement detection may be set, through the user interface.

The displaying unit 310 may also include the user interface as described above. In addition, the displaying unit 310 may also display the information required for sensing the movement and the result of sensing the movement. In this case, the information displayed on the displaying unit 310 may also be received from the first wireless communication apparatus 210.

In addition, the displaying unit 310 may also include a sound outputting device such as speaker, or the like. In this case, the displaying unit 310 may provide voice guide on the movement of the second wireless communication apparatus 280 and generate an alarm sound according to the setting.

It is possible to allow the second wireless communication apparatus 280 only to serve to send out radio wave signals so that the first wireless communication apparatus 210 may judge whether or not the second wireless communication apparatus 280 has moved. In this case, the second wireless communication apparatus 280 may not include the controlling unit 300 and the displaying unit 310 as described above but may only transmit the radio waves through the transceiving unit 290 at a predetermined time.

Here, the first and second wireless communication apparatuses 210 and 280 may use the same wireless communication scheme. Although the exemplary embodiment of the present invention has described that the first and second wireless communication apparatuses 210 and 280 use Wi-Fi, the present invention is not limited thereto. That is, the first and second wireless communication apparatuses 210 and 280 may use various wireless communication schemes. For example, various wireless communication schemes such as Wi-Fi, wireless broadband (Wibro), ultra wide band (UWB), Bluetooth, RFID, and the like, may be used.

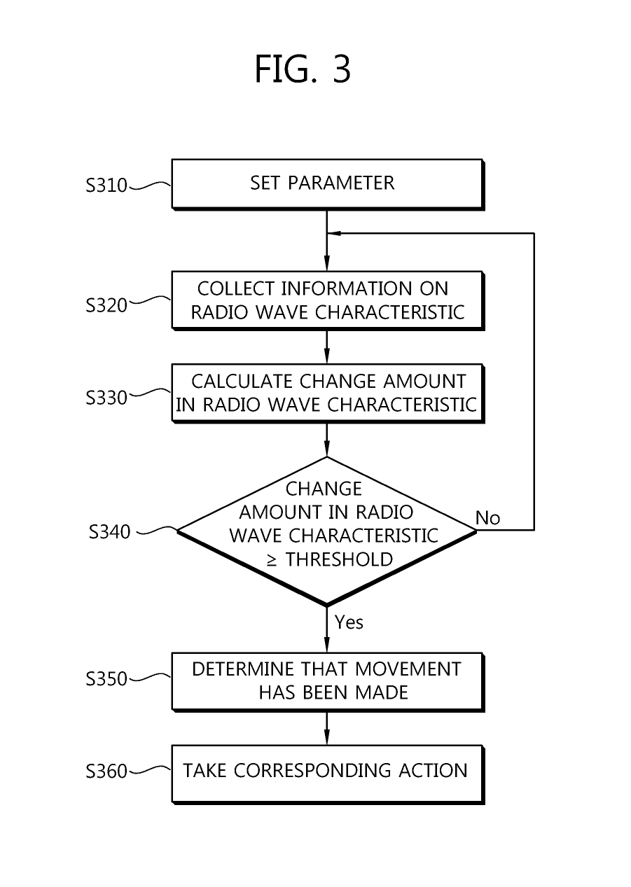

FIG. 3 is a flow chart schematically describing a method for determining whether or not movement has been made in a system according to the exemplary embodiment of the present invention.

When a procedure of sensing movement starts, an apparatus for sensing movement periodically or aperiodically receives radio waves from a movement sensed target and collects information on characteristics of corresponding radio waves (S320).

If needed, the apparatus for sensing movement may set a parameter corresponding to relative movement of the movement sensed target (S310). For example, a pairing procedure in which the apparatus for sensing movement and the movement sensed target recognize each other may be performed before the procedure of sensing movement starts.

In addition, it is possible to allow the apparatus for sensing movement to recognize movement in each direction of the movement sensed target and set commands corresponding thereto. In this case, when the procedure of sensing movement starts and the movement of the movement sensed target is sensed, a command corresponding to a corresponding movement direction may be performed. For example, a case of positioning the apparatus for sensing movement in a broadcasting service outputting apparatus such as a television (TV), positioning the movement sensed target in a terminal apparatus such as a cellular phone, and controlling the TV using the cellular phone instead of a remote controller may be considered.

The apparatus for sensing movement calculates a change amount in radio wave characteristics based on the collected information on radio wave characteristics (S330).

The apparatus for sensing movement judges whether the change amount in radio wave characteristics is a predetermined threshold or more (S340). When change amount in radio wave characteristics is less than the predetermined threshold, the apparatus for sensing movement judges that the movement has not been made between the apparatus for sensing movement and the movement sensed target and again performs the operation (S320) of collecting the information on radio waves characteristics and the operations following the operation (S320).

When the change amount in radio wave characteristics is a predetermined threshold or more, the apparatus for sensing movement judges that the movement sensed target has relatively moved with respect to the apparatus for sensing movement (S350).

In this case, the apparatus for sensing movement takes required corresponding actions (S360). The required corresponding action may be preset. For example, it is possible to allow the apparatus for sensing movement and/or the movement sensed target to generate an alert sound in order to prevent theft. In the case in which the movement sensed target is the terminal and the apparatus for sensing movement is the TV, the TV sensing the movement of the terminal may perform a predetermined operation such as a channel change. In addition, in the case in which movement of a movement sensed target attached to a building, or the like, is sensed, for example, in the case of a collapse of the building, an earthquake, or the like, information on the collapse of the building, the earthquake, or the like, may be transmitted to a disaster center.

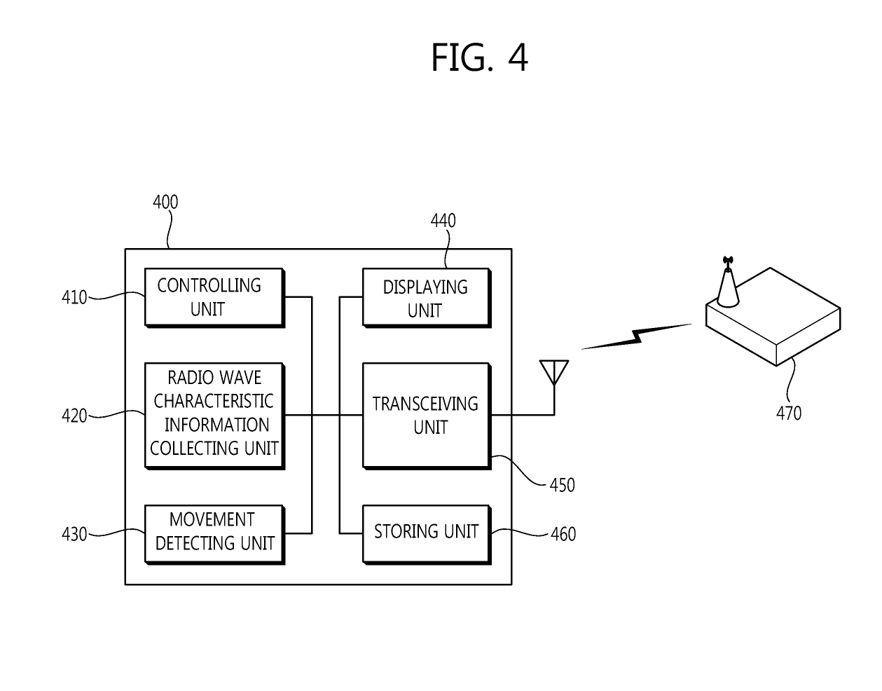

FIG. 4 is a diagram schematically describing an example of preventing theft of an article using the system according to the exemplary embodiment of the present invention.

Here, for convenience of explanation, a case in which the second wireless communication apparatus 400 is a Wi-Fi access point (AP) having a fixed position and the first wireless communication apparatus 210 is mounted as the apparatus for sensing movement in a notebook computer will be described by way of example.

Since the Wi-Fi AP transmits radio waves only at a predetermined position, the second wireless communication apparatus 400 needs not to include a controlling unit or a displaying unit.

When a notebook computer user starts a procedure of sensing movement, movement of the notebook computer starts to be sensed using the Wi-Fi AP positioned around the notebook computer through the controlling unit 220.

A radio wave characteristic information collecting unit 230 and a movement detecting unit 240 receives the radio waves from the Wi-Fi AP, collects information on radio wave characteristic, and judges whether relative movement has been made between the notebook computer 210 and the Wi-Fi AP 400, as described above.

When it is judged that the relative movement has been made between the notebook computer 210 and the Wi-Fi AP 400, that is when the movement detecting unit 240 judges that the notebook computer 210 has moved, the movement detecting unit 240 transfers a signal indicating that the notebook computer 210 has moved to the controlling unit 220. When the controlling unit 220 receives the signal indicating that the notebook computer 210 has moved, the controlling unit 220 takes required action. For example, the controlling unit 220 may inform the user that the notebook computer has moved by sounding an alert. The user may perform the presetting so that required action is taken when the notebook computer moves without his/her intention.

Although the exemplary embodiment of the present invention has described the notebook computer, the present invention is not limited thereto. That is, the present invention may also be applied to main articles requiring the prevention of theft, such as an automobile, or the like. For example, the present invention may be applied in order to prevent theft of a vehicle using a wireless communication apparatus positioned at a parking place, such as a Wi-Fi AP, or the like, and a wireless communication apparatus attached to a vehicle.

In addition, when the present invention is applied, the user may utilize the notebook computer or the wireless communication apparatus installed in the vehicle as they are without possessing additional communication devices.

Although the exemplary embodiment of the present invention has described that the notebook computer of which movement is sensed moves, the present invention is not limited thereto. Whether or not the notebook computer has moved may also be judged by using the notebook computer as the movement sensed target, attaching an apparatus for transmitting radio waves attached to the notebook computer or allowing the radio waves to be transmitted from a communication apparatus of the notebook computer, and receiving the radio waves in the movement sensing apparatus.

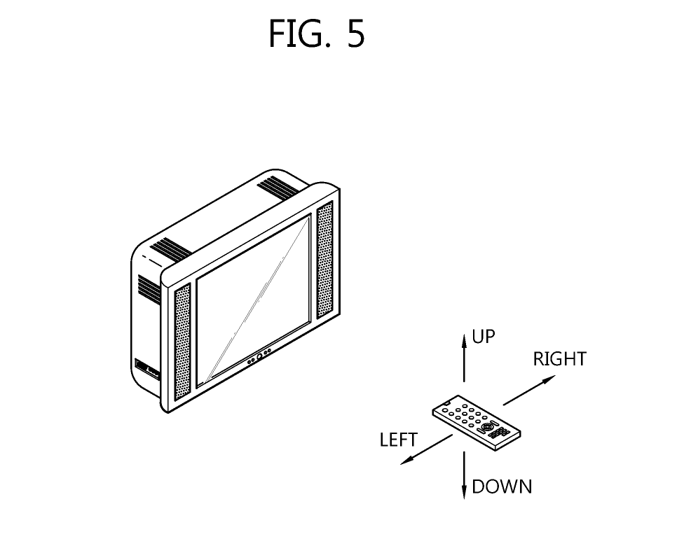

FIG. 5 is a view schematically showing a method for recognizing and using a movement direction of a remote controller according to the exemplary embodiment of the present invention. In the present embodiment, it is assumed that a TV serves as an apparatus for detecting movement, which is the first wireless communication apparatus 210, and a remote controller serves as a movement detected target, which is the second wireless communication apparatus 280.

According to the related art, the user selects an input button of the remote controller to transfer corresponding information to the TV, thereby controlling the TV. According to the present invention, since fine movement of the movement sensed target may be sensed, it is possible to control the TV using the movement of the remote controller.

The TV and the remote controller may perform local area communication in a scheme such as Bluetooth, or the like. The TV and the remote controller performs position recognition pairing for mutual initial positions by exchanging ID information with each other through each of their controlling units, or the like.

Then, the user performs position initialization through the controlling unit of the remote controller. The user allows the TV to collect information on radio wave characteristics according to a movement direction while moving the remote controller toward upper and lower sides and left and right sides. At this time, the user may also specify a parameter allowing a specific command to be performed according to each movement direction. For example, in the case in which the remote controller moves upwardly, a parameter corresponding to a change in radio wave characteristics in this case may be specified to change a channel of the TV, and in the case in which the remote controller moves downwardly, a parameter corresponding to a change in radio wave characteristics in this case may be specified to change the channel of the TV reversely to the above-mentioned case. Likewise, the user may also specify a parameter so as to allow the TV to change a sound amount, corresponding to horizontal movement of the remote controller. The controlling unit 220 may store parameters corresponding to each movement and information on commands indicated by the parameters in the storing unit 270.

Then, when a procedure of sensing movement starts, the radio wave characteristics information collecting unit 230 of the TV collects information on characteristics of radio waves transmitted from the remote controller, and the movement detecting unit 240 informs the controlling unit 220 that the remote controller has moved in a preset direction when it judges that the remote controller has moved in the preset direction. The controlling unit 220 performs a command indicated by the parameter corresponding to the movement of the remote controller.

Although the exemplary embodiment of the present invention has described that the parameters are set with respect to four axes of the upper and lower sides and the left and right sides of the remote controller, the present invention is not limited thereto. That is, the present invention may also be equally applied to movement of 6 or more axes of the remote controller.

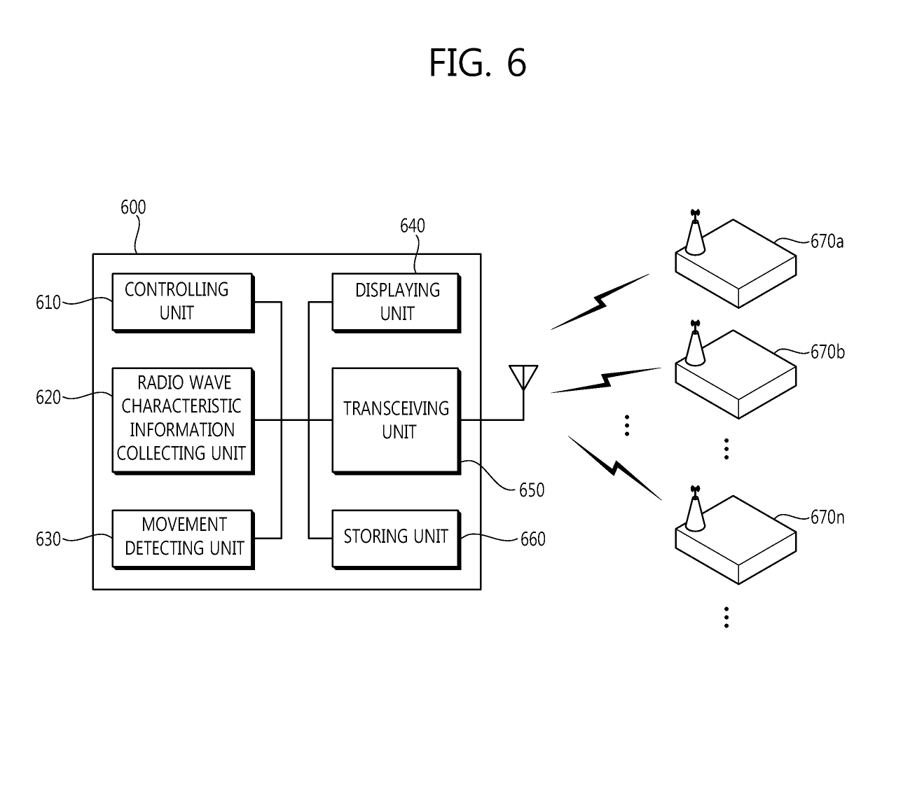

FIG. 6 is a diagram schematically describing a method for coping with a disaster according to the exemplary embodiment of the present invention.

The apparatus for sensing movement 210 receives radio waves from a plurality of movement sensed targets 600a, 600b, . . . , 600n, . . . and detects a change in radio wave characteristics for each of movement sensed targets. In order to detect the change in radio wave characteristics for each of movement sensed targets, the respective movement sensed targets 600a, 600b, . . . , 600n, . . . may use different frequencies.

The movement sensed targets 600a, 600b, . . . , 600n, . . . may be mounted on a plurality of positions on inner and outer portions of a building. The movement sensed targets 600a, 600b, . . . , 600n, . . . may also be mounted on a plurality of buildings.

Here, the movement detecting unit 240 of the movement sensing apparatus 210 judges that a movement sensed target has moved when a change amount in characteristics of radio waves transmitted by the movement sensed target is a predetermined threshold or more. A case in which the movement sensed target fixed to the building moves means that a disaster situation such as a collapse of the building or an earthquake occurs.

When the controlling unit 220 receives a signal indicating that a specific movement detected target has moved from the movement detecting unit 240, the controlling unit 220 may transfer information thereon to the system management center, or the like, or generates an alert through a sound device that may be provided in the displaying unit 250, or the like.

Here, the user sets a threshold of radio wave characteristics for determining the movement as a small amount, thereby making it possible to take required action such as escape or evacuation before the disaster completely occurs.

Although the exemplary embodiment of the present invention has described that the present invention is applied to the building, the present invention is not limited thereto. That is, the present invention may be applied in order to prevent a disaster such as a collapse of a road or a bridge, landslide, or the like, and minimize damage thereof.

According to the exemplary embodiments of the present invention, it is possible to accurately sense movement of a sensed target in real time.

According to the exemplary embodiments of the present invention, it is possible to sense movement of a sensed target even in the case in which an obstacle is present between the sensed target and a sensor or a line of sight is not secured.

According to the exemplary embodiments of the present invention, it is possible to sense omnidirectional movement of a sensed target and sense movement of a sensed target without directly contacting the sensed target or being positioned at a distance close to the sensed target.

According to the exemplary embodiments of the present invention, it is possible to sense movement between wireless apparatuses by using a general communication device as it is without being limited to a specific wireless communication scheme.

In the above-mentioned exemplary system, although the methods have described based on a flow chart as a series of steps or blocks, the present invention is not limited to a sequence of steps but any step may be generated in a different sequence or simultaneously from or with other steps as described above. Further, it may be appreciated by those skilled in the art that steps shown in a flow chart is non-exclusive and therefore, include other steps or deletes one or more steps of a flow chart without having an effect on the scope of the present invention.

The above-mentioned embodiments include examples of various aspects. Although all possible combinations showing various aspects are not described, it may be appreciated by those skilled in the art that other combinations may be made. Therefore, the present invention should be construed as including all other substitutions, alterations and modifications belong to the following claims.

What is claimed is:

1. A method for sensing movement, the method comprising:
receiving radio waves transmitted from a movement sensed target and collecting information on predetermined characteristics of the radio waves;
calculating a change amount in characteristics of the radio waves based on the information on characteristics of the radio waves;
determining whether the change amount in characteristics of the radio waves is a predetermined threshold or more; and
determining that movement has been made between an apparatus for sensing movement and the movement sensed target when the change amount in characteristics of the radio waves is the predetermined threshold or more.

2. The method of claim 1, wherein the information on characteristics of the radio waves is one of information on channel impulse response or information on received signal strength.

3. The method of claim 1, further comprising setting a parameter corresponding to a reference position of the movement sensed target and a parameter corresponding to movement with respect to the reference position,
wherein if it is determined that the movement has been made between the apparatus for sensing movement and the movement sensed target, an operation indicated by the parameter corresponding to the movement is performed.

4. The method of claim 3, wherein in the setting of the parameter corresponding to the movement, a parameter corresponding to a movement direction of the movement is set, and wherein when it is determined that the movement has been made, a command indicated by the parameter corresponding to the movement direction of the movement is performed by sensing the movement direction of the movement.

5. The method of claim 1, further comprising outputting a message informing the movement when it is determined that the movement has been made between the apparatus for sensing movement and the movement sensed target.

6. The method of claim 5, wherein the message is output as a sound.

7. The method of claim 1, further comprising initializing a position of the movement sensed target after it is determined that the movement has been made,
wherein the collecting of the information on characteristics of the radio waves, the calculating of the change amount in characteristics of the radio waves, the determining whether the change amount in characteristics of the radio waves is a predetermined threshold or more, and the determining that movement has been made between an apparatus for sensing movement and the movement sensed target are again performed with respect to the movement sensed target.

8. An apparatus for sensing movement, the apparatus comprising:
a transceiving unit receiving signals from a movement sensed target;
a characteristic collecting unit collecting information on characteristics of radio waves of the signals received by the transceiving unit; and
a movement detecting unit determining whether movement has been made between an apparatus for sensing movement and the movement sensed target based on the information on characteristics of radio waves collected by the characteristic collecting unit,
wherein the movement detecting unit determines that the movement has been made between the apparatus for sensing movement and the movement sensed target when a change amount in the information on characteristics of the radio waves is a predetermined threshold or more.

9. The apparatus of claim 8, further comprising a controlling unit taking corresponding action when the movement detecting unit determines that the movement has been made.

10. The apparatus of claim 9, wherein the characteristics collecting unit has an indication parameter set to take predetermined action corresponding to each movement direction based on an initial position with respect to the movement sensed target,
the movement detecting unit detects the movement direction together with whether or not the movement of the movement sensed target has been made, and
the controlling unit takes action indicated by an indication parameter corresponding to the movement direction of the movement sensed target detected by the movement detecting unit.

11. The apparatus of claim 8, wherein the transceiving unit transmits information on the movement determined by the movement detecting unit to a control center managing the movement sensed target, and
the transmission of the information on the movement is performed by request of the control center or periodically.

12. The apparatus of claim 8, further comprising a displaying unit outputting information on the movement determined by the movement detecting unit.

13. The apparatus of claim 10, wherein the displaying unit includes a sound outputting unit outputting a sound,
wherein the sound outputting unit outputs a predetermined sound when the movement detecting unit determines that the movement has been made between the apparatus for sensing movement and the movement sensed target.
